(19) United States
(12) Patent Application Publication
(10) Pub. No.: US 2008/0088268 A1
(43) Pub. Date: Apr. 17, 2008

(54) Fan Motor Drive Device and Cooler

(75) Inventor: Takahiro Sakaguchi, Kyoto (JP)

Correspondence Address: CANTOR COLBURN, LLP, 20 Church Street, 22nd Floor, Hartford, CT, 06103, US

(73) Assignee: ROHM CO., LTD., KYOTO JAPAN (JP)

(21) Appl. No.: 11/663,780

(22) PCT Filed: Aug. 26, 2005
(86) PCT No.: PCT/JP05/15532

§ 371 Date: Mar. 26, 2007

(30) Foreign Application Priority Data
Sep. 24, 2004 (JP) 2004-276961
Dec. 13, 2004 (JP) 2004-360279
Jun. 23, 2005 (JP) 2005-182878

(51) Int. Cl. H02P 23/14

(52) U.S. Cl. 318/471

(57) ABSTRACT

A fan motor driving apparatus which can set the frequency of a cooling fan flexibly is provided. The fan motor driving apparatus drives a fan at the frequency based on the control voltage and the ambient temperature, thereby cooling a target CPU. The first control unit includes a thermostor and a first resistor and outputs a first voltage obtained by multiplying the control voltage by a first coefficient dependent on the ambient temperature. The second control unit outputs a second voltage obtained by multiplying the control voltage by a predetermined coefficient. The selection unit selects the higher of the first and the second voltages, and outputs the selected voltage to a drive control unit. The drive control unit drives the fan motor based on the voltage.

### BACKGROUND OF THE INVENTION

1. Field of the Invention

The present invention relates to a fan motor driving apparatus, and more particularly, to a technology in which cooling is controlled by detecting temperature.

2. Description of the Related Art

As personal computers and work stations are operated at an increasing high speed recently, the operating speed of processing LSIs (Large Scale Integrated Circuits) such as CPUs (Central Processor Units), DSPs (Digital Signal Processors) and the like has been continuing to increase.

Such a LSI has a greater calorific value, as the operating speed, that is, the clock frequency becomes higher. A calorific value from a LSI has a problem in that it would lead the LSI to the thermal runaway or affect a surrounding circuit. Accordingly, appropriate cooling a LSI is an extremely important technology.

As an example of technology for cooling a LSI, there is known an air-cooling method using a cooling fan. In the method, a cooling fan, for example, is provided facing the surface of the LSI, and cold air is blown against the surface of the LSI from the cooling fan. In such a cooling method using a cooling fan, the degree of cooling is adjusted by changing the rotation of a fan in accordance with the temperature, while monitoring the temperature around the LSI. (See Patent Documents 1 and 2.)

Patent Document 1: Japanese Patent Application Laid-open No. Hei7-31190.

Patent Document 2: Japanese Patent Application Laid-open No. 2001-284868.

Meanwhile, a calorific value and the temperature, the threshold temperature of thermal runaway and the like often differ from LSI to LSI. Accordingly it would be desirable that the rotation speed of a cooling fan be set flexibly in accordance with the target LSI to be cooled.

Also, in a cooling apparatus for cooling a LSI, there is a case when a changeover between the two cooling modes is desired. Of the two cooling modes, one is the mode in which a cooling fan is controlled in accordance with the ambient temperature, and the other is the mode in which a cooling fan is controlled in accordance with a control signal which is supplied from outside, regardless of the ambient temperature. There are many cases in which pulse width modulated signals controlling the frequency in accordance with the duty ratio are supplied as control signals from outside.

Now, a case will be considered in which the two aforementioned cooling modes are switched from one to the other in accordance with the availability of a control signal input from outside. In this case, cooling is done based on a control signal when the signal is input. Cooling is done based on the ambient temperature when a control signal is not input. One method for achieving such changeover of the cooling modes is to provide a cooling apparatus with a microcomputer to determine the availability of a control signal. However, using an expensive microcomputer for a cooling apparatus makes product cost increase.

### SUMMARY OF THE INVENTION

The present invention is made in view of such problems, and a first general purpose of one embodiment of the present invention is to provide a fan motor driving apparatus and a cooling apparatus in which the frequency of a cooling fan motor can be set flexibly in accordance with the temperature, and thereby a target object can be cooled to a desired degree.

A second general purpose of another embodiment of the invention is to provide a motor driving apparatus and a cooling apparatus in which cooling modes can be switched in accordance with the availability of a control signal, without cost increase.

An embodiment of the present invention relates to a fan motor driving apparatus. The fan motor driving apparatus comprises: a first control unit which outputs a first voltage obtained by multiplying a control voltage which controls a frequency of a fan motor by a first coefficient dependant on the ambient temperature; a second control unit which outputs a second voltage obtained by multiplying the control voltage by a predetermined second coefficient; selection unit which selects either the first voltage or the second voltage and outputs the voltage selected; and a drive control unit which drives the fan motor based on the output of the selection unit. The first coefficient and the second efficient are determined to be equal at a predetermined temperature at which the frequency of the fan motor reaches the upper limit.

The selection unit selects and outputs the lower of the first and the second voltages when the first coefficient has positive temperature characteristics, and outputs the higher when the first coefficient has negative temperature characteristics.

According to the embodiment, a fan motor is driven at a frequency determined based on the first voltage dependent on both the temperature and the control voltage, at the predetermined temperature or below. When the predetermined temperature is exceeded, a fan motor is driven at a frequency determined based on the second voltage dependent only on the control voltage. In other words, according to the embodiment, the upper limit of the frequency of a fan motor is set for each control voltage, and thereby the frequency of the fan motor can be fixed to the upper limit value when the temperature is equal to or higher than the predetermined temperature.

The drive control unit may include a pulse width modulator which produces a pulse width modulated signal of which the duty ratio changes in accordance with the voltage output from the selection unit, and a drive unit which drives a fan motor based on a pulse width modulated signal produced by the pulse width modulator. The pulse width modulator may produce a pulse width modulated signal of which the upper limit value of the duty ratio is determined in accordance with the second voltage. When driving a fan motor in the Pulse Width Modulation (hereinafter referred to as “PWM”) system, the duty ratio can be determined based on the first and the second voltages and the fan motor can be driven at the frequency in accordance with the duty ratio.

The first control unit may include a first resistor and a thermistor, and multiply the resistively divided control voltage by the first coefficient dependent on the ambient temperature. The dependency of the first coefficient on the ambient temperature can be adjusted by the resistance value of the first resistor, the positive or negative temperature characteristics of the resistance value of the thermistor, and connection between the first resistor and the thermistor.

The selection unit may include an output terminal, a voltage comparator which compares the first and the second voltages, and a switch which applies either the first voltage or the second voltage to the output terminal, wherein the switch is controlled based on the output of the voltage comparator.

The control voltage which controls a frequency of a fan motor may be a pulse width modulated signal, and the first and the second control units may output voltages obtained by multiplying the control voltage smoothed by the smoothing filters by the first and the second coefficients, respectively.

Another embodiment of the present invention also relates to a fan motor driving apparatus. The fan motor driving apparatus comprises: a control unit which outputs a voltage obtained by multiplying a control voltage which controls a frequency of a fan motor by a predetermined coefficient; a selection unit which selects either an output voltage of the control unit or an predetermined reference voltage, and outputs the voltage selected as a voltage that defines a minimum frequency of the fan motor; and a drive control unit which drives the fan motor based on the control voltage, wherein the drive control unit drives the fan motor at or above the minimum frequency which is determined in accordance with the voltage output from the selection unit.

According to the embodiment, since the minimum frequency of a fan motor is determined by the voltage output from the selection unit, the frequency is never equal to or under the frequency determined by the reference voltage so that the frequency is always maintained at or over a constant frequency, even when the voltage of the control voltage becomes low.

The drive control unit may include a pulse width modulator which produces a pulse width modulated signal of which the duty ratio changes in accordance with the control voltage, and a drive unit which drives a fan motor based on the pulse width modulated signal produced by the pulse width modulator. The pulse width modulator may produce a pulse width modulated signal with the minimum duty ratio determined in accordance with the voltage output from the selection unit. When driving a fan motor in PWM system, the duty ratio of a pulse width modulated signal can be determined based on both the control voltage and the output voltage of the selection unit, and the fan motor can be rotated at the frequency in accordance with the duty ratio.

The control voltage which controls a frequency of a fan motor may be a pulse width modulated signal, and the control unit output a voltage obtained by multiplying the control voltage smoothed by a smoothing filter by a predetermined coefficient.

Still another embodiment of the present invention relates to a cooling apparatus. The cooling apparatus includes a fan motor and a fan motor driving apparatus described above.

According to the embodiment, the minimum and the maximum frequencies of a fan motor can be set flexibly and thereby an target can be cooled to a degree desired.

A fan motor driving apparatus according to a still another embodiment of the present invention includes a smoothing circuit which smoothes a pulse width modulated control signal which controls a frequency of a fan motor and outputs the smoothed voltage as a first control voltage, a second control voltage generator which outputs a second control voltage that controls a frequency of a fan and is dependent on the temperature, a selection unit which selects and outputs either the first control voltage or the second control voltage based on the comparison result between the first control voltage and the predetermined reference voltage, and a drive control unit which drives the motor based on the outputs of the selection unit.

The smoothing circuit may generate the first control voltage so that the first control voltage increases as the duty ratio of the control signal becomes greater, and in addition to that, the selection unit may receive the first and the second control voltages, and the selection unit may output the first control voltage when the first control voltage is lower than the predetermined reference voltage, and output the second control voltage when the first control voltage is higher.

According to the embodiment, it can be determined whether a control signal is input from outside or not, by smoothing a pulse width modulated control signal and comparing the signal with the reference voltage. Accordingly, the driving mode of a cooling fan can be switched between the mode based on the control signal and the mode based on the second control voltage, in accordance with the availability of a control signal from outside.

The smoothing circuit may include: a transistor with its emitter grounded, the base terminal of which receives an input of a pulse width modulated control signal; a capacitor which is connected to the collector terminal of the transistor; and a pull-up resistor which is connected to the base terminal of the transistor, wherein a signal appearing at the collector terminal of the transistor may be output as a first control voltage. The first control voltage can be stabilized when a control signal is not input, by connecting a pull-up resistor to the base terminal of the transistor to which the input of the control signal is input,

The second control voltage generator may include a group of resistors to which a constant voltage is applied, the group comprising a first resistor and a thermistor connected in series, and the second control voltage generator may output the voltage at the connection point of the first resistor and the thermistor as the second control voltage.

The selection unit may include a voltage comparator which compares the first control voltage with the reference voltage, and a switch which outputs either the first control voltage or the second control voltage based on the comparison result of the voltage comparator. The circuit can be simplified by constituting the selection unit with a comparator and a switch.

Another embodiment of the present invention relates to a cooling apparatus. The apparatus includes a fan motor and an aforementioned fan motor driving apparatus which controls the driving of the fan motor. According to the embodiment, the control of rotation of a fan motor can be switched in accordance with the availability of input of a control signal and thereby a target can be cooled to a degree desired.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the structure of a fan motor driving apparatus according to a first embodiment;

FIGS. 2A and 2B are graphs showing the relationships among a first voltage V1, a second voltage V2, an output voltage Vx and ambient temperature Ta;

FIG. 3 shows the relationship among a voltage Vx, a periodic voltage Vosc and a PWM signal Vpwm;

FIG. 4 is a graph showing the relationship between the frequency of the fan motor of the first embodiment and the ambient temperature, using a control voltages as a parameter;

FIG. 5 shows the structure of the driving apparatus for a fan motor according to a second embodiment;

FIG. 6 shows the relationship among the voltage Vx, a voltage Vmin, the periodic voltage Vosc and the PWM signal Vpwm;

FIG. 7 is a graph showing the relationship between the output voltage and the control voltage of a second selection unit;

FIG. 8 is a graph showing the relationship between the frequency of the fan motor and the ambient temperature according to the second embodiment, using the control voltage as a parameter;

FIG. 9 shows the structure of the cooling apparatus according to a third embodiment;

FIG. 10 is a circuit diagram showing the structure of a smoothing circuit;

FIG. 11 is a graph showing the input-output characteristics of the smoothing circuit of FIG. 10;

FIG. 12 is a circuit diagram showing the exemplary structure of a selection unit, and

FIG. 13 shows the relationship among the control voltage, the periodic voltage and the PWM signal.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

### First Embodiment

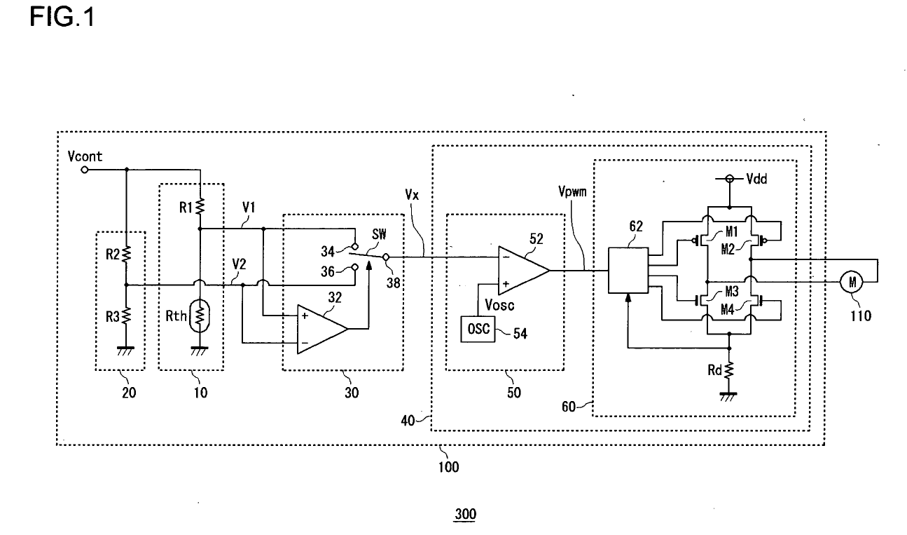

With regard to the embodiments of the invention, a fan motor driving apparatus which is mounted on electric computers such as personal computers or work stations to drive a fan motor for cooling CPUs and the like, will be discussed as an example. FIG. 1 shows the structure of a cooling apparatus 300 including a fan motor driving apparatus 100 in accordance with a first embodiment. The cooling apparatus 300 includes the fan motor driving apparatus 100 and a fan motor 110. The fan motor 110 is provided close to a target CPU to be cooled (not shown). The fan motor driving apparatus 100 is connected to the fan motor 110 and drives the fan at the frequency based on a control voltage Vcont and the ambient temperature Ta, thereby cooling the target CPU.

The fan motor driving apparatus 100 includes a first control unit 10, a second control unit 20, a selection unit 30 and a drive control unit 40. A control voltage Vcont which directs the frequency of the fan motor is input to the fan motor driving apparatus 100.

The first control unit 10 outputs the product obtained by multiplying the control voltage Vcont by a first coefficient dependent on the ambient temperature Ta, as a first voltage V1. The first control unit 10 includes a thermistor Rth and a first resistor R1. The thermistor Rth and the first resistor R1 are connected in series between a terminal to which the control voltage Vcont is applied and the ground potential, and output the resistively divided voltage at the connection point of the two resistors, as the first voltage V1. The thermistor Rth is provided around the target CPU to be cooled and has a resistance value that changes in accordance with the ambient temperature Ta.

The first voltage V1 is given by V1=Vcont×Rth/(R1+Rth) using the control voltage Vcont, the first resistor R1 and the thermistor Rth. Since the resistance value of the thermistor Rth is given as a function of the ambient temperature Ta, the constant of proportionality Rth/(R1+Rth) is dependent on the ambient temperature Ta. The constant of proportionality will be referred to as a first coefficient a1.

When the resistance value of the thermistor Rth has negative temperature characteristics, the first coefficient a1 also has negative temperature characteristics; therefore, the first voltage V1 decreases as the ambient temperature Ta increases.

The second control unit 20 includes a second resistor R2 and a third resistor R3. The second control unit 20 resistively divides the control voltage Vcont with the second resistor R2 and the third resistor R3, and outputs the product obtained by multiplying the divided voltage by a second coefficient a2, as the second voltage V2. The second coefficient a2 is given by a2=R3/(R2+R3) using the resistance values of the second resistor R2 and the third resistor R3. The second voltage V2 which is the output voltage of the second control unit 20 is given by V2=a2×Vcont=R3/(R2+R3)×Vcont, where the second coefficient a2 is a constant value independent of the ambient temperature Ta.

The first voltage V1 which is output from the first control unit 10, and the second voltage V2 which is output from the second control unit 20 are input to the selection unit 30. The selection unit 30 selects and outputs the first voltage or the second voltage, whichever is higher. The selection unit 30 includes a first voltage comparator 32 and a switch SW. The first voltage comparator 32 compares the first voltage V1 with the second voltage V2, and then outputs a high level when V1>V2 or a low level when V1<V2.

The switch SW includes a first input terminal 34, a second input terminal 36 and an output terminal 38. The first input terminal 34 and the second input terminal 36 are applied with the first voltage V1 and the second voltage V2, respectively. The switch SW is connected to the first input terminal 34 when the voltage which is output from the first voltage comparator 32 is high, and is connected to the second input terminal 36 when the voltage is low. As a result, V1 is output from the output terminal 38 when the comparison result of the voltages in the first voltage comparator 32 shows V1>V2, and V2 is output when V1<V2. Thus, the selection unit 30 selects and outputs the first voltage V1 or the second voltage V2, whichever is higher.

Now, the first coefficient a1 and the second coefficient a2 are set to be equal at a predetermined temperature at which the frequency of the motor should reach the upper limit. That is, given that the temperature at which the frequency of the fan motor should reach the upper limit is Tmax and the resistance value of the thermistor Rth at the temperature is Rth(Tmax), the resistance values are selected so that Rth(Tmax)/(R1+Rth(Tmax))=R3/(R2+R3) holds.

The first coefficient a1 has negative temperature characteristics, and the second coefficient a2 has a constant value independent of the temperature. Therefore, when the ambient temperature Ta<Tmax, a1>a2 holds, and, when Ta>Tmax, a1<a2 holds.

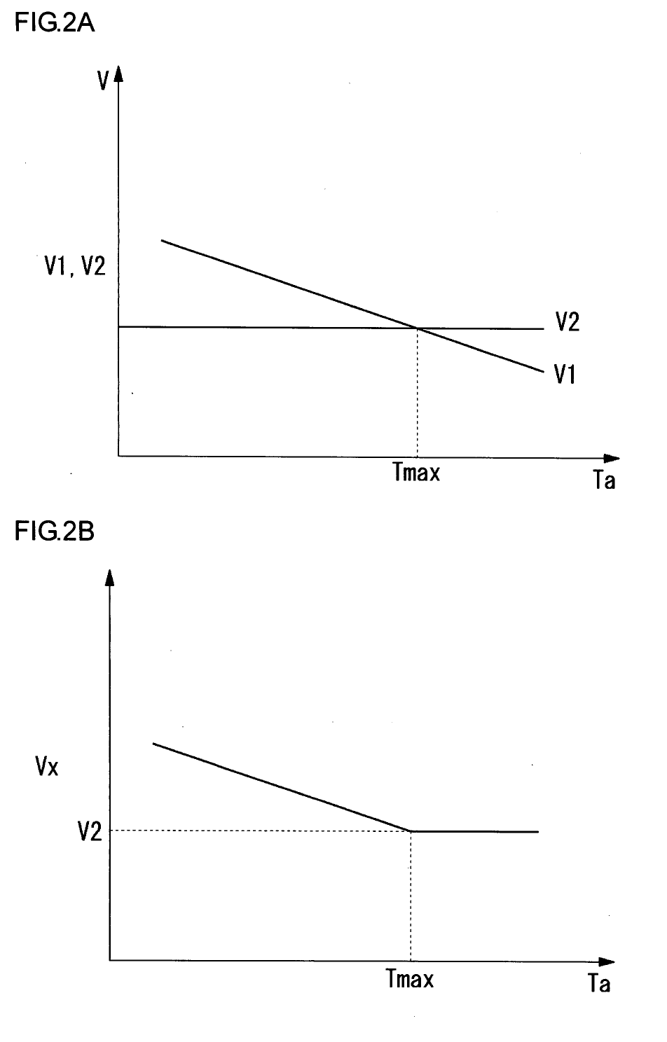

FIG. 2 A and FIG. 2 B show the relationships among the first voltage V1, the second voltage V2, an output voltage Vx and the ambient temperature Ta. As shown in FIG. 2A, since the first voltage V1 and the second voltage V2 are values obtained by multiplying the control voltage Vcont by the coefficients a1 and a2, respectively, the magnitude relation between the first voltage V1 and the second voltage V2 is V1>V2 when Ta<Tmax, V2>V1 when Ta>Tmax. As a result, the voltage Vx which is output from the selection unit 30 is determined by the ambient temperature Ta. The first voltage V1 is selected and output as the voltage Vx when Ta<Tmay, and the second voltage V2 when Ta>Tmax, as shown in FIG. 2B.

The voltage Vx which is output from the selection unit 30 is input to the drive control unit 40. The drive control unit 40 includes a pulse width modulator 50 and a drive unit 60, and drives a fan motor 110 based on the input voltage Vx.

The pulse width modulator 50 includes a second voltage comparator 52 and an oscillator 54, and produces a PWM signal Vpwm of which the on-period changes based on the input voltage Vx. The oscillator 54 outputs a periodic voltage Vosc with a triangular or sow-tooth waveform. Further, the pulse width modulator 50 may include an amplifier which amplifies the input voltage Vx by a given amplification factor, which makes wide settings possible in association with the characteristics of the thermistor Rth, by converting the voltage Vx into a suitable signal level.

Vx and Vosc are input to the second voltage comparator 52 from the selection unit 30 and the oscillator 54, respectively. The second voltage comparator 52 compares the voltage Vx with the periodic voltage Vosc, and outputs the PWM signal at a high level when Vosc>Vx, and the signal at a low level when Vosc<Vx. The PWM signal Vpwm represents a pulse width modulated signal of which the periods of the high level and the low level change in accordance with the magnitude of the voltage Vx.

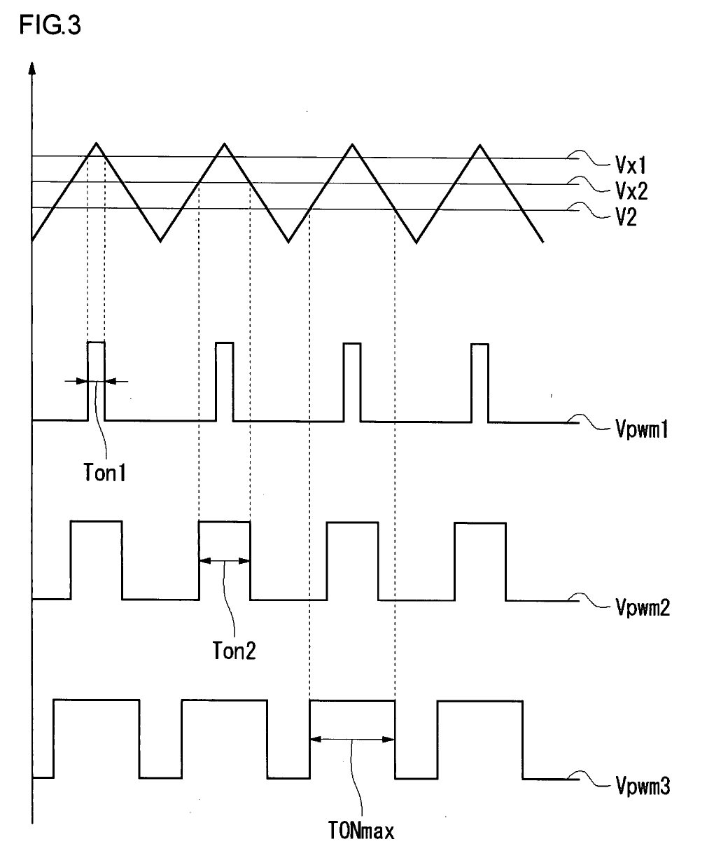

FIG. 3 shows the relationship among the voltage Vx, the periodic voltage Vosc and the PWM signal Vpwm. As the value of the voltage Vx drops to Vx1 and then Vx2, the on-period of the PWM signal Vpwm becomes longer. The output voltage Vx of the selection unit 30 never becomes lower than the second voltage V2 which is determined by the second control unit 20, as shown in FIG. 2. That is, the on-period of the PWM signal has the TONmax as the upper limit value. The PWM signal Vpwm which is produced by the pulse width modulator 50 is input to the drive unit 60.

The drive unit 60 drives the fan motor 110 based on the PWM signal Vpwm, and includes a driver circuit 62, switching transistors M1 through M4 and a detection resistor Rd. The switching transistors M1 through M4 are MOSFETs, and conduct switching operations in accordance with the voltage which is applied to the gate terminal, providing the fan motor 110 with the driving voltage intermittently. These switching transistors M1 through M4 constitute an H-bridge circuit. The power supply voltage Vdd is applied to one of the terminals of the fan motor 110 and the voltage close to the ground potential is applied to the other terminal, enabling the fan motor 110 to rotate toward a direction, by maintaining the switching transistors M2 and M3 turned off, and turning on and off the switching transistors M1 and M4 synchronously. The detection resistor Rd converts a motor current which flows in the fan motor 110 into a voltage and feeds the voltage back to the driver circuit 62.

The driver circuit 62 controls the on-off of the switching transistors M1 through M4, based on both the PWM signal Vpwm which is output from the pulse width modulator 50 and the feedback voltage from the detection resistor Rd. The driver circuit 62 turns on either the pair of the switching transistors M1 and M4 or the pair of the switching transistors M2 and M3, thereby applying the driving voltage to the fan motor 110, during the on-period Ton of the PWM signal Vpwm. Therefore, the longer the on-period of the PWM signal Vpwm, the longer the driving voltage is applied to the fan motor 110, which makes the fan motor 110 rotates at a greater torque, that is, at a higher rotation speed.

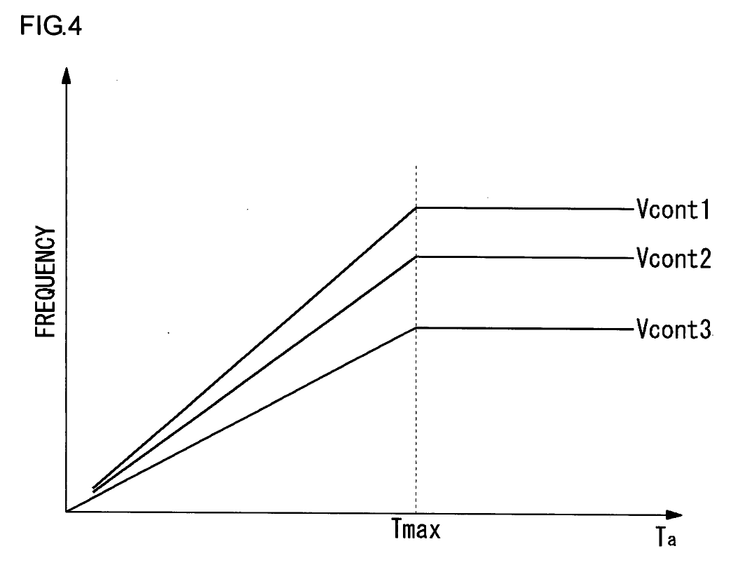

FIG. 4 shows the relationship between the frequency of the fan motor 110 and the ambient temperature Ta, using the control voltage Vcont as a parameter. As shown in FIG. 3, the on-period of the PWM signal Vpwm is determined by the voltage vx which is output from the selection unit 30, and the voltage Vx has the temperature dependency shown in FIG. 2B. Also, since the first voltage V1 and the second voltage V2 are both proportional to the control voltage Vcont, the output voltage Vx of the selection unit 30 is also proportional to the control voltage Vcont. As the output voltage Vx of the selection unit 30 is lower, that is, as the control voltage Vcont is lower, the on-period of the PWM signal is longer, which leads to an increase in the frequency of the fan motor 110.

As the ambient temperature Ta increases, the output voltage Vx of the selection unit 30 becomes lower as shown in FIG. 2. Therefore, the frequency of the fan motor 110 increases. However, when the ambient temperature reaches a constant temperature Tmax, the output voltage Vx assumes a constant value, resulting in the on-period of the PWM signal Vpwm reaching TONmax, which makes the frequency of the fan motor 110 maintained at a constant value.

As described above, according to the fan motor driving apparatus 100 in accordance with the embodiment, the frequency of the fan motor 110 is changed in accordance with both the control voltage Vcont and the ambient temperature Ta. However, when the temperature reaches a constant temperature Tmax, the frequency can be maintained at a constant value and prevented from increasing. Since the temperature Tmax at which the frequency will reach the upper limit value can be adjusted by the resistors of the first control units 10 and the second control unit 20, the degree of cooling by the cooling apparatus can be changed flexibly by means of the CPU.

### Second Embodiment

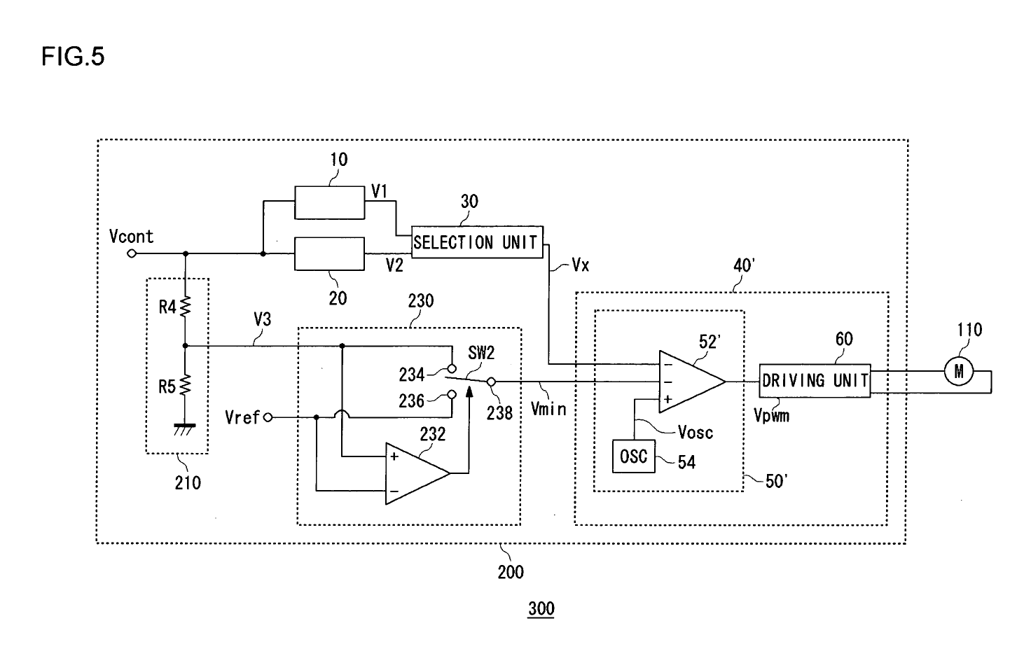

FIG. 5 shows the structure of a fan motor driving apparatus 200 according to a second embodiment. The fan motor driving apparatus 100 according to the first embodiment is the technology to limit the upper limit frequency of the fan motor 110. In contrast, the fan motor driving apparatus 200 according to the present embodiment incorporates a technology to control the lower limit of the frequency of the fan motor 110.

The fan motor driving apparatus 200 includes a third control unit 210 and a second selection unit 230 in addition to the constituting elements of the fan motor driving apparatus 100 of FIG. 1. In FIG. 5, the same constituting elements as in FIG. 1 shall be denoted by the same reference symbols, and explanations shall be omitted appropriately.

The third control unit 210 includes a fourth resistor R4 and a fifth resistor R5. The third control unit 210 resistively divides the control voltage Vcont with the fourth resistor R4 and the fifth resistor R5, and outputs the product obtained by multiplying the divided voltage by a third coefficient a3, as a third voltage V3. The third coefficient a3 is given by a3=R5/(R4+R5), using the resistance values of the fourth resistor R4 and the fifth resistor R5. The third voltage V3 which is the output voltage of the third control unit 210 is given by V3=a3×Vcont=R5/(R4+R5)×Vcont. The third coefficient a3 is a constant value independent of the ambient temperature Ta.

The third voltage V3 which is output from the third control unit 210 and a reference voltage Vref are input to the second selection unit 230. The second selection unit 230 selects and outputs the the third voltage V3 or the reference voltage Vref, whichever is lower. The second selection unit 230 includes a third voltage comparator 232 and a second switch SW2. The third voltage comparator 232 compares the third voltage V3 with the reference voltage Vref, and outputs a high level when V3>Vref and a low level when V3<Vref.

The second switch SW2 has input terminals 234 and 236 and an output terminal 238. The third voltage V3 and the reference voltage Vref are applied to the input terminal 234 and the input terminal 236, respectively. The second switch SW2 is connected to the input terminal 234 when the voltage which is output from the third voltage comparator 232 is low, and is connected to the input terminal 236 when the voltage is high. As a result, Vref is output to the output terminal 238 when the comparison result of the voltages in the third voltage comparator 232 shows V3>Vref, and V3 is output when V3<Vref. Thus, the selection unit 230 selects the third voltage V3 or the reference voltage Vref, whichever is lower, and outputs the selected voltage as an output voltage Vmin.

The output voltage Vmin is input to a drive control unit 40′ along with the output voltage Vx from the selection unit 30. A second voltage comparator 52′ produces the PWM signal Vpwm based on the three voltages Vosc, Vx and V min. The second voltage comparator 52′ compares the voltage Vx with the voltage Vmin, and produces the PWM signal based on the lower the voltages and on the periodic voltage Vosc.

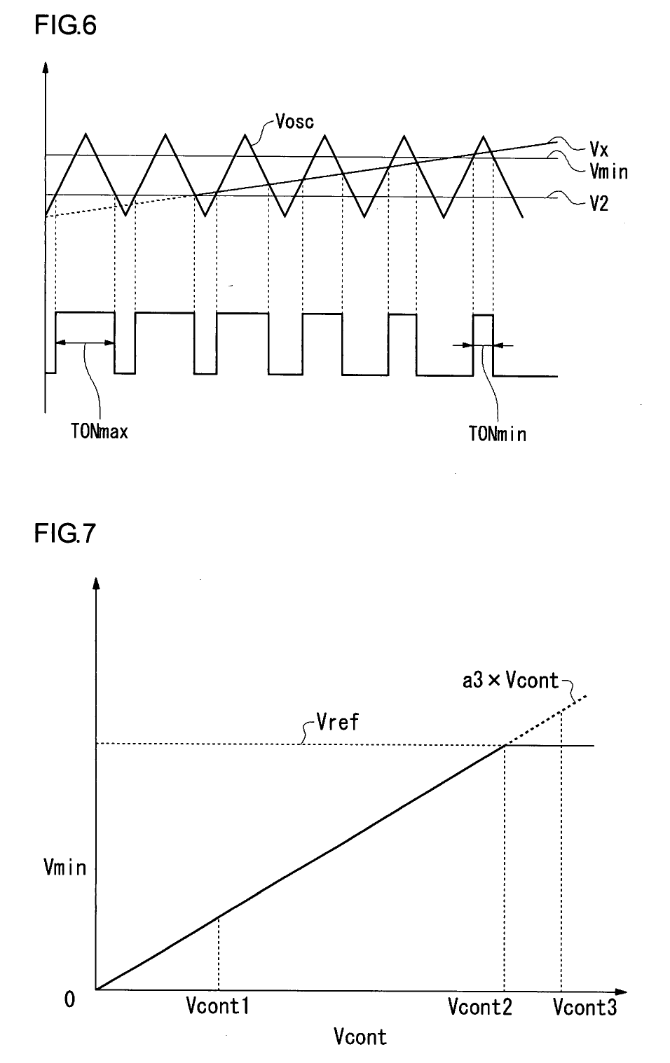

FIG. 6 shows the relationship among the voltages Vx and Vmin, the periodic voltage Vosc and the PWM signal Vpwm. As the output voltage Vx of the selection unit 30 increases, the on-period of the PWM signal Vpwm becomes shorter. However, when Vx>Vmin, the on-period reaches the minimum and no longer becomes shorter. That is, the frequency of the fan motor 110 will not be equal to or below the minimum frequency which is determined by the output voltage Vmin of the second selection unit 230.

FIG. 7 shows the relationship between the output voltage Vmin of the second selection unit 230 and the control voltage Vcont. The second selection unit 230 selects and outputs the third voltage V3 which is proportional to the control voltage Vcont, or the reference voltage Vref, whichever is lower. Accordingly, as the control voltage Vcont is increased, the third voltage V3 is increased proportionally; however, the output voltage Vmin of the second selection unit 230 will never be equal to or above the reference voltage Vref.

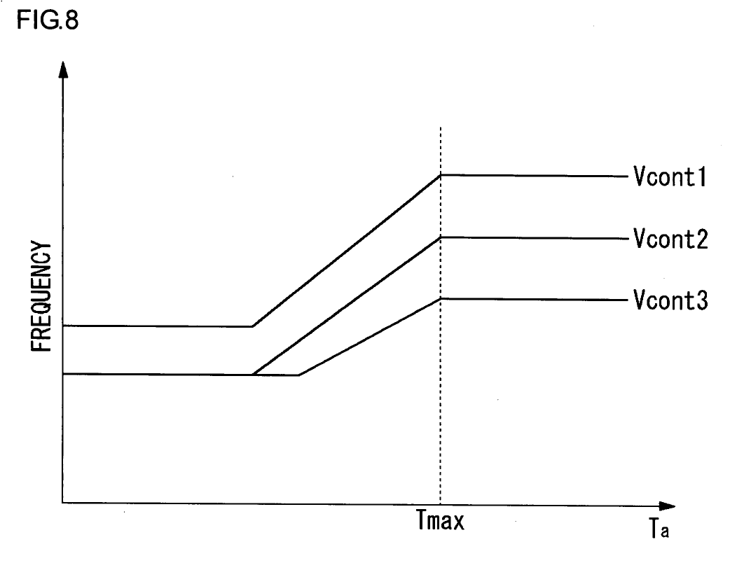

FIG. 8 shows the relationship between the frequency of the fan motor 110 according to the second embodiment and the ambient temperature Ta, using the control voltage Vcont as a parameter. As the control voltage Vcont increases, the frequency of the fan motor 110 decreases; however, the frequency will never be equal to or below the minimum frequency occurring when Vmin=Vref.

Thus, according to the fan motor driving apparatus 200 according to the second embodiment, the frequency of the fan motor 110 can be set so as to be equal to or above the minimum frequency, regardless of the control voltage Vcont.

The particular embodiment disclosed herein is intended to be illustrative only. It will be appreciated by those skilled in the art that various modifications to the constituting elements and processes could be developed and that such modifications are within the scope of the present invention.

In the above embodiment, a case in which the control voltage Vcont is provided in the form of a direct-current voltage is described; however, the control voltage Vcont may be a pulse width modulated signal. In this case, the control voltage may be smoothed by a smoothing filter before being input to the first control unit 10, the second control unit 20 and the third control unit 210. An ordinal RC filter or the like may be used as a smoothing filter.

In the first or second embodiments, the functions of the selection unit 30 or the second selection unit 230 may be implemented by using a minimum circuit or a maximum circuit. In addition, while the thermistor of the embodiment is described as having negative temperature characteristics, the thermistor may be a posistor having positive temperature characteristics. In the case, the selection unit 30 may select and output the first voltage V1 or the second voltage V2, whichever is lower.

In the first or second embodiments, all the elements which are included in the fan motor driving apparatuses 100 and 200 may be integrated entirely, or may be integrated as separate ICs. Some of the elements may be implemented as discrete components. The target for integration may be decided in accordance with the cost, occupied area or usage.

In addition, in the first or the second embodiments, a case in which the cooling apparatus 300 is mounted on an electric computer to cool a CPU is described; however, applications of the present invention are not limited to this and can be used for various applications in which heat generating elements are cooled.

### Third Embodiment

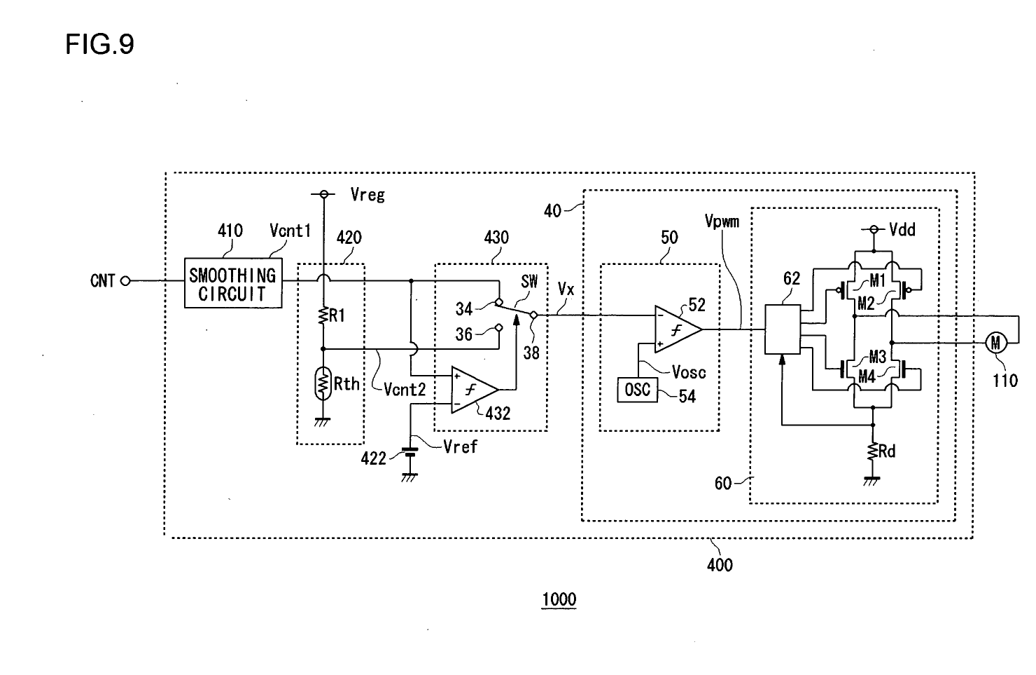

FIG. 9 shows the structure of a cooling apparatus 1000 according to a third embodiment. The cooling apparatus 1000 includes the fan motor 110 and a fan motor driving apparatus 400 which controls the fan motor 110, and drives the fan at the frequency based on either a control signal CNT which is provided from outside or the ambient temperature Ta, so as to cool a target CPU to be cooled.

The fan motor driving apparatus 400 includes: a smoothing circuit 410; a second control voltage generator 420; a reference voltage supply 422; a selection unit 430; and the drive control unit 40.

The control signal CNT which directs the frequency of the fan motor 110 is input to the fan motor driving apparatus 400 from outside. The control signal CNT is pulse width modulated, and the frequency of the fan motor 110 is controlled in accordance with the duty ratio.

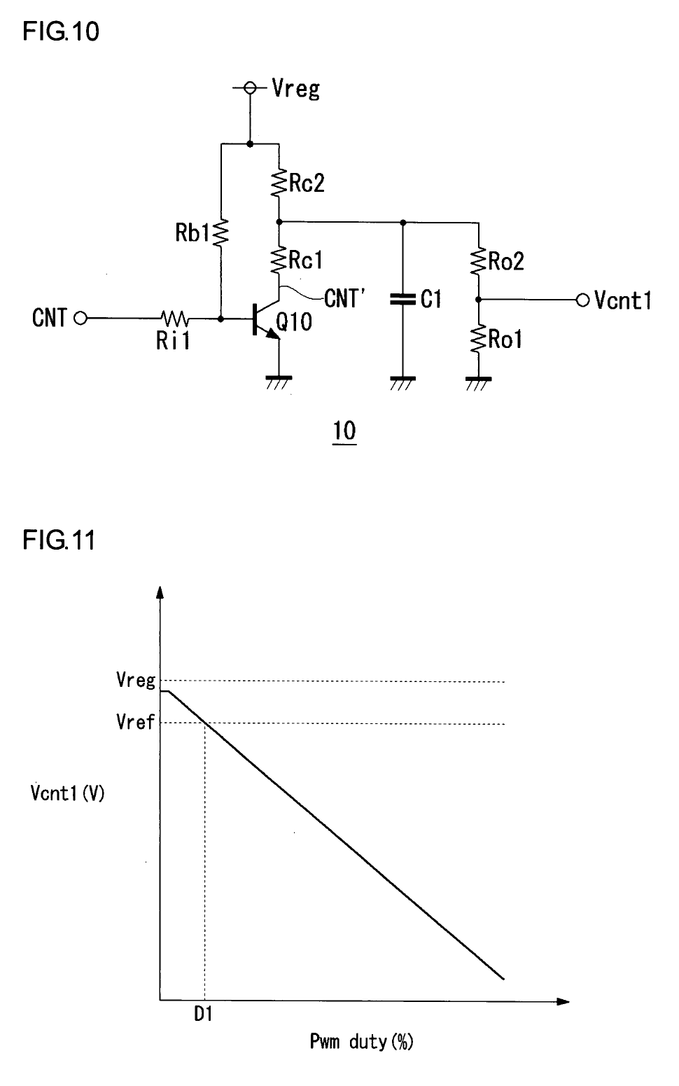

The smoothing circuit 410 smoothes the pulse width modulated control signal CNT, and outputs the smoothed signal as the first control voltage Vcnt1. FIG. 10 is a circuit diagram showing the structure of the smoothing circuit 410. The smoothing circuit 410 includes an input resistor Ri1, a transistor Q10, a pull-up resistor Rb1, a first collector resistor Rc1, a second collector resistor Rc2, a smoothing capacitor C1, a first output resistor Ro1, and a second output resistor Ro2.

The transistor Q10 has its emitter grounded, and the pulse width modulated control signal CNT is input to the base terminal thereof. The input resistor Ri1 is connected to the base terminal of the transistor Q10 and adjusts the input impedance of the smoothing circuit 410. A stabilized voltage Vreg is applied to the collector terminal of the transistor Q10 through the first collector resistor Rc1 and the second collector resistor Rc2. The pull up resistor Rb1 is connected to the base terminal of the transistor Q10 and stabilizes the base voltage at the voltage Vreg when the control signal CNT which is to be the input signal is not input.

The smoothing capacitor C1 is provided between the connection point of the first collector resistor Rc1 and the second collector resistor Rc2, and the ground potential. An inversion of the control signal CNT, which is amplified by the transistor Q10 with its emitter grounded, is output from the collector. The smoothing capacitor C1, the first collector resistor Rc1 and the second collector resistor Rc2 constitute a low pass filter so that an amplified control signal CNT′ which is output from the collector terminal of the transistor Q10 is output with high frequency components removed by the low pass filter.

In the output stage of the smoothing circuit 410, a first output resistor Ro1 and a second output resistor Ro2, which are connected in series, are connected in parallel with the smoothing capacitor C1. The smoothing circuit 410 resistively divides the control signal, which is smoothed by the smoothing capacitor C1, by the first output resistor Ro1 and the second output resistor Ro2, and outputs the voltage appearing at the connection node of the two resistors as a first control voltage Vcnt1. In addition, the first control voltage Vcnt1 may be output from the connection point of the smoothing capacitor C1 and the second output resistor Ro2, instead of the connection point of the first output resistor Ro1 and the second output resistor Ro2.

FIG. 11 shows the input-output characteristics of the smoothing circuit 410. The horizontal axis of FIG. 11 represents the duty ratio of the pulse width modulated control signal CNT, and the vertical axis represents the first control voltage Vcont which is output from the smoothing circuit 410. In the smoothing circuit 410 of FIG. 10, the signal CNT which is input to the base terminal of the transistor Q10 is inverted in level with respect to the signal CNT′ appearing at the collector terminal. Accordingly, as the duty ratio of the control voltage CNT which is input to the base terminal of the transistor Q10 increases, the duty ratio of the control signal CNT′ appearing at the collector terminal decreases.

As a result, the first control voltage Vcnt1 with its high frequency components removed by the smoothing capacitor C1 assumes a value determined by the duty ratio of the control signal CNT which is input from outside. As shown in FIG. 11, the first control voltage Vcnt1 assumes a value close to the stabilized constant voltage Vreg which is applied to the collector terminal of the transistor Q1, when the duty ratio of the first control signal CNT is low. The first control voltage Vcnt1 becomes low as the duty ratio increases. Thus, the smoothing circuit 410 smoothes the pulse width modulated control signal CNT and outputs the smoothed signal to the selection unit 430 in the subsequent stage.

Referring back to FIG. 9, the second control voltage generator 420 generates a second control voltage Vcnt2 dependent on the ambient temperature Ta which controls the frequency of the fan motor 110. The second control voltage generator 420 has the first resistor R1 and the thermistor Rth connected in series and includes a group of resistors to which the stabilized constant voltage Vreg is applied. The thermistor Rth is provided around a target CPU to be cooled and its resistance value changes in accordance with the ambient temperature Ta. The second control voltage generator 420 outputs a voltage at the connection point of the first resistor R1 and the thermistor Rth as the second control voltage Vcnt2. The second control voltage Vcnt2 is given by Vcnt2=Vreg×Rth/(R1+Rth) using the first resistor R1, the resistance value of the thermistor Rth and the constant voltage Vreg. The resistance value of the thermistor Rth has negative temperature characteristics; therefore, the resistance value decreases as the ambient temperature Ta increases. The second control voltage Vcnt2 with a voltage value decreasing as the ambient temperature Ta increases is output from the second control voltage generator 420 configured as described above.

The selection unit 430 selects either the first control voltage Vcnt1 or the second control voltage Vcnt2 described above, and outputs the voltage selected as the control voltage Vx. The selection unit 430 includes a first voltage comparator 432 and a switch SW. The reference voltage Vref which is output from the reference voltage supply 422 is input to the selection unit 430 in addition to the first control voltage Vcnt1 and the second control voltage Vcnt2.

The first voltage comparator 432 compares the first control voltage Vcnt1 and the reference voltage Vref, and outputs a high level when Vcnt1>Vref, and a low level when Vcont1<Vref.

The switch SW includes the first input terminal 34, the second input terminal 36 and the output terminal 38. The first input terminal 34 and the second input terminal 36 are applied with the first control voltage Vcnt1 and the second control voltage Vcnt2, respectively. The switch SW is connected to the first input terminal 34 when the voltage which is output from the first voltage comparator 432 is low, and connected to the second input terminal 36 when the voltage is high. As a result, the second control voltage Vcnt2 appears at the output terminal 38, when Vcnt1>Vref, and the first control voltage Vcnt1 appears when Vcnt1<Vref. The selection unit 430 outputs either the first control voltage Vcnt1 or the second control voltage Vcnt2 which appear at the output terminal 38, to the drive control unit 40, as the control voltage Vx.

The switch SW of the selection unit 430 may be formed by a transfer gate which uses a MOS (Metal Oxide Semiconductor Field Effect Transistor) or the like. Also, a switch element which is commercially available may be used as the switch SW.

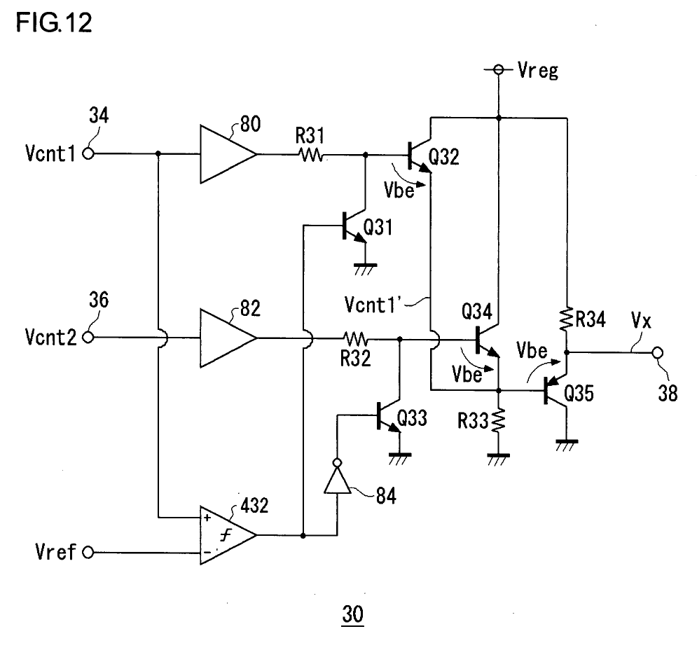

The selection unit 430 may be configured as shown in FIG. 12. The selection unit 430 in FIG. 12 includes the first voltage comparator 432, a first buffer 80, a second buffer 82, resistors R31, R32, R33, and R34, transistors Q31, Q32, Q33, Q34 and Q35, and an inverter 84.

The first control voltage Vcnt1 which is input to the first input terminal 34 is input to the base terminal of the transistor Q32 which is an NPN bipolar transistor, through the first buffer 80 and the resistor R31. The transistor Q31 which functions as a switching element is connected between the base terminal of the transistor Q32 and the ground potential. The output from the first voltage comparator 432 is input to the base terminal of the transistor Q31.

The emitter terminal of the transistor Q32 is connected to the base terminal of the transistor Q35. Between the base terminal of the transistor Q35 and the earth, the resistor R33 for stabilizing the circuit operation is connected.

The second buffer 82, the resistor R32 and the transistors Q33 and Q34 are provided to correspond to the aforementioned first buffer 80, the resistor R31, and the transistors Q31 and Q32, respectively. The inverter 84 is connected to the base terminal of the transistor Q33 which corresponds to the transistor Q31, and an inversion of the output of the first voltage comparator 432 is input thereto.,

The transistor Q35 provided in the output stage of the selection unit 430 is a PNP bipolar transistor, serving as the output transistor. The stabilized voltage vreg is applied to the emitter terminal of the transistor Q35 through the resistor R34. The emitter terminal of the transistor Q35 is connected to the output terminal 38 which outputs the control voltage Vx.

The output of the first voltage comparator 432 is input to the transistor Q33 through the inverter 84, and is directly input to the transistor Q31; therefore, either of the transistor Q31 or the transistor Q33 turns on. That is, when Vcnt1>Vref, the transistor Q31 turns on and the transistor Q33 off because the first voltage comparator 432 outputs the high level. Conversely, when Vcnt1<Vref, the transistor Q31 turns off and the transistor Q33 on.

Since turning on the transistor Q31 when Vcnt1>Vref makes the potential at the base terminal of the transistor Q32 decrease to nearly the ground potential and fixed, the transistor Q32 turns off. At the time, since the transistor Q33 turns off conversely, the second control voltage Vcnt2 which is input to the base terminal of the transistor Q34 is amplified, which makes the voltage at the emitter terminal (Vcnt2−Vbe). Since the emitter terminal of the transistor Q34 is connected to the base terminal of the transistor Q35, the voltage at the base terminal of the transistor Q35 also becomes (Vcnt2−Vbe). As a result, the second control voltage Vcnt2 is output as the control voltage Vx from the output terminal 38, which is the emitter terminal of the transistor Q35.

On the other hand, since the transistor Q33 turns on when Vcnt1<Vref, the transistor Q34 turns off. At the time, since the transistor Q31 turns off conversely, the first control voltage Vcnt1 which is input to the base terminal of the transistor Q32 is amplified, which makes the voltage (Vcnt1−Vbe) appear at the emitter terminal, that is, the base terminal of the transistor Q35. As a result, the first control voltage Vcnt1 is output as the control voltage Vx from the output terminal 38, which is the emitter terminal of the transistor Q35.

Referring back to FIG. 9, the control voltage Vx which is output from the selection unit 430 is input to the drive control unit 40. The drive control unit 40 includes the pulse width modulator 50 and the drive unit 60, and drives the fan motor 110 based on the input control voltage Vx.

The pulse width modulator 50 includes the second voltage comparator 52 and the oscillator 54, and produces the PWM (Pulse Width Modulator) signal Vpwm of which the on-period changes, based on the input control voltage Vx. The oscillator 54 outputs the periodic voltage Vosc with a triangular or saw-tooth waveform. Further, the pulse width modulator 50 may include an amplifier which amplifies the input voltage Vx by a given amplification factor, which makes wide settings possible in association with the characteristics of the thermistor Rth, by converting the control voltage Vx into a suitable signal level.

The control voltage Vx and the periodic voltage Vosc are input to the second voltage comparator 52 from the selection unit 430 and the oscillator 54, respectively. The second voltage comparator 52 compares the control voltage Vx with the periodic voltage Vosc, and outputs a PWM signal at a high level when Vosc>Vx, and the signal at a low level when Vosc<Vx. The PWM signal Vpwm represents a pulse width modulated signal of which the periods of the high level and the low level change in accordance with the magnitude of the control voltage Vx.

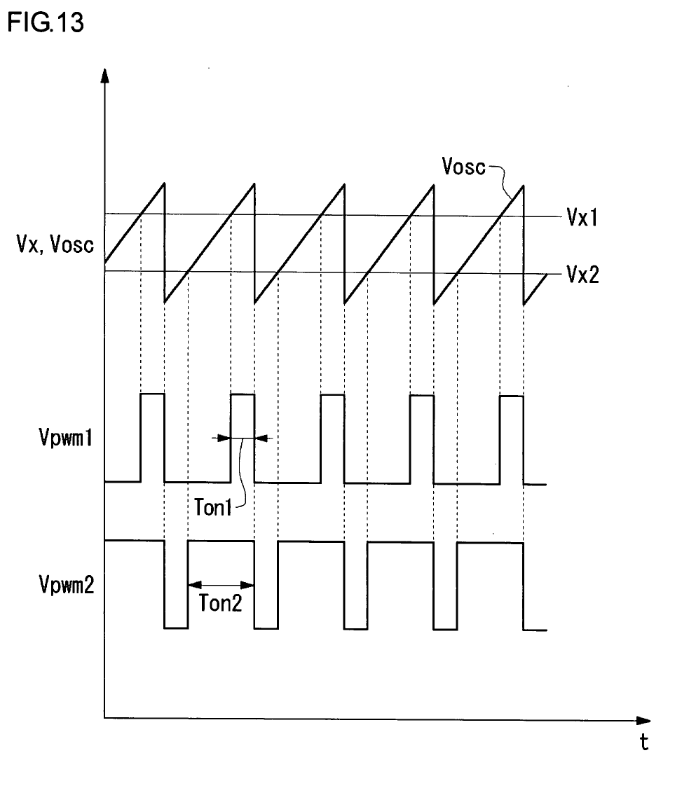

FIG. 13 shows the relationship among the control voltage Vx, the periodic voltage Vosc and the PWM signal Vpwm. As the voltage Vx drops to reach Vx1 and then Vx2, the on-period of the PWM signal Vpwm becomes longer. That is, the duty ratio becomes higher. When the control voltage Vx which is output from the selection unit 430 is the first control voltage Vcnt1, the duty ratio of the PWM signal Vpwm varies based on the control signal CNT which is input from outside. As described above, since the first control voltage Vcnt1 becomes lower as the duty ratio of the control signal CNT becomes higher, the duty ratio of the PWM signal Vpwm increases.

Further, when the control voltage Vx which is output from the selection unit 430 is the second control voltage Vcnt2, the duty ratio of the PWM signal Vpwm varies in accordance with the ambient temperature Ta. As described above, since the second control voltage Vcnt2 becomes lower as the ambient temperature Ta becomes higher, the duty ratio of the PWM signal Vpwm increases. The PWM signal which is produced by the pulse width modulator 50 is input to the drive unit 60.

The drive unit 60 drives the fan motor 110 based on the PWM signal Vpwm, and includes the driver circuit 62, the switching transistors M1 through M4 and the detection resistor Rd. The switching transistors M1 through M4 are MOSFETs, and conduct switching operations in accordance with the voltage which is applied to the gate terminal, providing the fan motor 110 with the driving voltage intermittingly. These switching transistors M1 through M4 constitute an H-bridge circuit. The power supply voltage Vdd is applied to one of the terminals of the fan motor 110 and the voltage close to the ground potential is applied to the other terminal, enabling the fan motor 110 to rotate toward a direction, by turning off the switching transistors M2 and M3 and turning on the switching transistors M1 and M4 synchronously. The detection current Rd converts a motor current which flows in the fan motor 110 into a voltage to feedback the voltage to the driver circuit 62.

The driver circuit 62 controls the on/off of the switching transistors M1 through M4, based on both the PWM signal Vpwm which is output from the pulse width modulator 50 and the feedback voltage from the detection resistor Rd. The driver circuit 62 turns on either the pair of the switching transistors M1 and M4 or the pair of switching transistors M2 and M3 and thereby applies the driving voltage to the fan motor 110, during the on-period Ton of the PWM signal Vpwm. Therefore, the longer the on-period of the PWM signal Vpwm, the longer the driving voltage is applied to the fan motor 110, which makes the fan motor 110 rotates at a greater torque, that is, at a higher rotation speed.

The operation of the fan motor driving apparatus 400 configured as described above will be explained. As shown in FIG. 11, the first control voltage Vcnt1 which is output from the smoothing circuit 410 is at maximum when the control signal CNT is not input to the fan motor driving apparatus 400, i.e., when the duty ratio is 0%. The first control voltage Vcnt1 becomes lower as the duty ratio of the control signal CNT is higher, resulting in being lower than the reference voltage Vref which is output from the reference power supply 422 when the duty ratio is greater than the predetermined duty ratio D1.

Therefore, the selection unit 430 outputs the second control voltage Vcnt2 when the first control voltage Vcnt1 is greater than the reference voltage Vref, that is, when the duty ratio of the control signal CNT is lower than the predetermined value D1. Conversely, when the first control voltage Vcnt1 is lower than the reference voltage Vref, that is, when the duty ratio of the control signal CNT is greater than the predetermined value D1, the selection unit 430 outputs the first control voltage Vcnt1.

The fan motor driving apparatus 400 controls a cooling fan in accordance with the ambient temperature Ta, based on the second control voltage Vcnt2, when the control signal CNT is not input, or when the duty ratio is lower than the predetermined value D1. The second control voltage Vcnt2 decreases as the ambient temperature Ta increases. As shown in FIG. 13, the drive control unit 40 produces a pulse width modulated signal Vpwm with a duty ratio which is higher as the control voltage Vx is lower. The frequency of the fan motor 110 increases and thereby the cooling capacity increases, as the ambient temperature Ta rises.

Also, the fan motor driving apparatus 400 controls the cooling based on the control signal CNT which is provided from outside, regardless of the ambient temperature Ta, when the control signal CNT with the duty ratio greater than the predetermined value D1 is input. Since the first control voltage Vcnt1 decreases as the duty ratio of the control signal CNT is greater, as shown in FIG. 11, the control voltage Vx which is output from the selection unit 430 also decreases. As a result, the duty ratio of the pulse width modulated signal Vpwm increases, which increases the frequency of the fan motor 110 and thereby the cooling capacity can be increased.

As described above, according to the fan motor driving apparatus 400 in accordance with the embodiment, the apparatus once converts the control signal CNT which is pulse width modulated by the smoothing circuit 410 into the dc first control voltage Vcnt1, then the selection unit 430 compares the voltage Vcnt1 with the reference voltage Vref to determine on the availability of the input. Thereafter, the drive control unit 40 returns the voltage to the PWM signal Vpwm again and thereby drives the fan motor 110.

According to the fan motor driving apparatus 400, the fan motor is driven at a frequency dependant on the ambient temperature Ta when the control signal CNT is not input, and is driven at the frequency dependant on the duty ratio of the control signal CNT when the control signal CNT is input.

Since the fan motor driving apparatus 400 according to the embodiment can determine on the availability of the control signal CNT, with a simple constitution using the smoothing circuit 410 and the selection unit 430, the apparatus to be made at a lower cost than when built with a microcomputer or the like.

The particular embodiment disclosed herein is intended to be illustrative only. It will be appreciated by those skilled in the art that various modifications to the constituting elements and processes could be developed and that such modifications are within the scope of the present invention.

In the third embodiment, the case is described in which the thermistor Rth used in the second control voltage generator 420 has negative temperature characteristics; however, the thermistor Rth may also be a posistor having positive temperature characteristics. In the case, the positions of the first resistor R1 and the thermistor Rth may be replaced with each other.

The setting of the logical high and low levels described in the third embodiment is only an example, and those values may be inverted by using an inverter or the like. The smoothing circuit 410 produces the first control voltage Vcnt1 which decreases as the duty ratio of the control signal CNT becomes greater; however, the reverse of it may be possible. For example, when the soothing circuit 410 is formed by an RC filter, the voltage value of the first control voltage Vcnt1 becomes greater as the duty ratio of the control signal CNT becomes greater. In the case, it may be possible to configure the second control voltage generator 420 such that the second control voltage Vcnt2 would have positive temperature characteristics, and to invert the logic entirely in the subsequent stage.

In the third embodiment, all the elements which are included in the fan motor driving apparatus 400 may be integrated entirely, or may be incorporated integrated as separate ICs. Some of the elements may be implemented as discrete components. The target for integration may be decided in accordance with the cost, occupied area or usage.

While the preferred embodiments of the present invention have been described using specific terms, such description is for illustrative purposes only, and it is to be understood that changes and variations may be made without departing from the spirit or scope of the appended claims.

1. A fan motor driving apparatus, comprising:
a first control unit which outputs a first voltage obtained by multiplying a control voltage which controls a frequency of a fan motor by a first coefficient dependant on the ambient temperature;
a second control unit which outputs a second voltage obtained by multiplying the control voltage by a predetermined second coefficient;
a selection unit which selects either the first voltage or the second voltage and outputs the voltage selected; and
a drive control unit which drives the fan motor based on the output of the selection unit, wherein the first coefficient and the second efficient are determined to be equal at a predetermined temperature at which the frequency of the fan motor reaches an upper limit, and the selection unit selects and outputs the lower of the first and the second voltages when the first coefficient has positive temperature characteristics, and outputs the higher when the first coefficient has negative temperature characteristics.

2. The fan motor driving apparatus according to claim 1, wherein the first control unit comprises:
a first resistor; and
a thermistor, wherein the first control unit multiplies the resistively divided control voltage by the first coefficient dependent on the ambient temperature.

3. The fan motor driving apparatus according to claim 1, wherein the selection unit comprises:
an output terminal;
a voltage comparator which compares the first and the second voltages; and
a switch which applies either the first voltage or the second voltage to the output terminal; and the switch is controlled based on the output of the voltage comparator.

4. The fan motor driving apparatus according to claim 1, wherein the control voltage which controls the frequency of the fan motor is a pulse width modulated signal, and the first and the second control units output voltages obtained by multiplying the control voltage smoothed by smoothing filters by the first and the second coefficients, respectively.

5. A fan motor driving apparatus comprising:
a control unit which outputs a voltage obtained by multiplying a control voltage which controls a frequency of a fan motor by a predetermined coefficient;
a selection unit which selects either an output voltage of the control unit or an predetermined reference voltage, and outputs the voltage selected as a voltage that defines a minimum frequency of the fan motor; and
a drive control unit which drives the fan motor based on the control voltage, wherein the drive control unit drives the fan motor at or above the minimum frequency which is determined in accordance with the voltage output from the selection unit.

6. The fan motor driving apparatus according to claim 5, wherein a control voltage which controls a frequency of the fan motor is a pulse width modulated signal, and the control unit outputs a voltage obtained by multiplying the control voltage smoothed by a smoothing filter by the predetermined coefficient.

7. A fan motor driving apparatus comprising:
a smoothing circuit which smoothes a pulse width modulated control signal which controls a frequency of a fan motor, and outputs the smoothed signal as a first control voltage;
a second control voltage generator which outputs a second control voltage that controls a frequency of a fan and is dependent on the temperature;
a selection unit which selects and outputs either the first control voltage or the second control voltage based on the comparison result between the first control voltage and the predetermined reference voltage; and
a drive control unit which drives the motor based on the outputs of the selection unit.

8. The fan motor driving apparatus according to claim 7, wherein the smoothing circuit comprises:
a transistor with its emitter grounded which receives at its base terminal the pulse width modulated control signal;
a capacitor which is connected to the collector terminal of the transistor; and
a pull-up resistor which is connected to the base terminal of the transistor, wherein
a signal appearing at the collector terminal of the transistor is output as the first control voltage.

9. The fan motor driving apparatus according to claim 7, wherein the second control voltage generator includes a group of resistors to which a constant voltage is applied, the group comprising a first resistor and a thermistor connected in series, and wherein the second control voltage generator outputs the voltage at the connection point of the first resistor and the thermistor as the second control voltage.

10. The fan motor driving apparatus according to claim 7, wherein the selection unit comprises:
a voltage comparator which compares the first control voltage with the reference voltage; and
a switch which outputs either the first control voltage or the second control voltage based on the comparison result of the voltage comparator.

11. A cooling apparatus comprising:
a fan motor; and
a fan motor driving apparatus according to claim 1 which controls the driving of the fan motor.

12. A cooling apparatus comprising:
a fan motor; and
a fan motor driving apparatus according to claim 7 which controls the driving of the fan motor.
